(19) United States
(12) Patent Application Publication
(10) Pub. No.: US 2026/0164373 A1
(43) Pub. Date: Jun. 11, 2026

(54) TECHNIQUES FOR HYPER-FRAME NUMBER (HFN) RE-SYNCHRONIZATION

(71) Applicant: QUALCOMM Incorporated, San Diego, CA (US)

(72) Inventors: Sherif ELAZZOUNI, San Diego, CA (US); Arun Prasanth BALASUBRAMANIAN, San Diego, CA (US); Arnaud MEYLAN, San Diego, CA (US); Soo Bum LEE, San Diego, CA (US); Ozcan OZTURK, San Diego, CA (US)

(21) Appl. No.: 18/975,910

(22) Filed: Dec. 10, 2024

(51) Int. Cl. H04W 56/00; H04W 76/19

(52) U.S. Cl. CPC H04W 56/001; H04W 76/19

(57) ABSTRACT

Methods, systems, and devices for wireless communications are described. In some cases, a user equipment (UE) may transmit a report indicative of hyper-frame number (HFN) desynchronization between the UE and a network entity. As such, to support HFN resynchronization, the UE may receive, from the network entity, a message indicative of an HFN associated with a packet data unit (PDU), where the UE deciphers the PDU based on the indicated HFN.

### FIELD OF TECHNOLOGY

The following relates to wireless communications, including techniques for hyper-frame number (HFN) resynchronization.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a report indicative of HFN desynchronization between the UE and a network entity and receiving a message indicative of a HFN associated with a PDU based on transmission of the report, where the UE deciphers the PDU based on the HFN.

A UE for wireless communications is described. The UE may include one or more memories storing processor executable code, and one or more processors coupled with the one or more memories. The one or more processors may individually or collectively be operable to execute the code to cause the UE to transmit a report indicative of HFN desynchronization between the UE and a network entity and receive a message indicative of a HFN associated with a PDU based on transmission of the report, where the UE deciphers the PDU based on the HFN.

Another UE for wireless communications is described. The UE may include means for transmitting a report indicative of HFN desynchronization between the UE and a network entity and means for receiving a message indicative of a HFN associated with a PDU based on transmission of the report, where the UE deciphers the PDU based on the HFN.

A non-transitory computer-readable medium storing code for wireless communications is described. The code may include instructions executable by one or more processors to transmit a report indicative of HFN desynchronization between the UE and a network entity and receive a message indicative of a HFN associated with a PDU based on transmission of the report, where the UE deciphers the PDU based on the HFN.

In some examples of the method, UEs, and non-transitory computer-readable medium described herein, the message includes a control message and the method, apparatuses, and non-transitory computer-readable medium may include further operations, features, means, or instructions for receiving, after the control message, the PDU.

In some examples of the method, UEs, and non-transitory computer-readable medium described herein, the control message comprises a first field that indicates that a second field in the control message is indicative of the HFN.

In some examples of the method, UEs, and non-transitory computer-readable medium described herein, the control message indicates a value of the HFN via a quantity of bits in the second field.

In some examples of the method, UEs, and non-transitory computer-readable medium described herein, the message may be indicative of a count value, and the message being indicative of the HFN may be based on the count value being based on the part on the HFN and a sequence number (SN) associated with the packet data unit.

In some examples of the method, UEs, and non-transitory computer-readable medium described herein, the message includes an indication that the message may be indicative of the count value.

In some examples of the method, UEs, and non-transitory computer-readable medium described herein, the message indicative of the count value may be received based on satisfaction of one or more conditions.

In some examples of the method, UEs, and non-transitory computer-readable medium described herein, the one or more conditions includes a change in a value of the HFN.

In some examples of the method, UEs, and non-transitory computer-readable medium described herein, the one or more conditions includes reception of a control message indicative of a change in structure of the message from a first structure to a second structure and the second structure supports an indication of the count value.

Some examples of the method, UEs, and non-transitory computer-readable medium described herein may further include operations, features, means, or instructions for receiving configuration information indicative of the one or more conditions.

In some examples of the method, UEs, and non-transitory computer-readable medium described herein, either the report or a control message transmitted by the UE may be indicative of one or more PDUs, including at least the PDU, missed by the UE based on the HFN desynchronization. In such cases, the method, apparatuses, and non-transitory computer-readable medium may include further operations, features, means, or instructions for receiving, after reception of the message indicative of the HFN, the one or more PDUs missed by the UE, where the PDU may be a first received PDU of the one or more PDUs based on the message being indicative of the HFN associated with the PDU.

In some examples of the method, UEs, and non-transitory computer-readable medium described herein, the HFN desynchronization may be associated with a first RLC entity of one or more RLC entities associated with the network entity and the method, apparatuses, and non-transitory computer-readable medium may include further operations, features, means, or instructions for releasing a communication link associated with the first RLC entity based on transmission of the report and re-establishing the communication link associated with the first RLC entity, where reception of the message indicative of the hyper-frame number may be based on re-establishment of the communication link.

In some examples of the method, UEs, and non-transitory computer-readable medium described herein, each PDU of the one or more PDUs may be associated with a respective count value and the one or more PDUs may be received in ascending order of the respective count values.

In some examples of the method, UEs, and non-transitory computer-readable medium described herein, the network entity may be associated with a first RLC entity and a second RLC entity, the UE supports a first communication link associated with the first RLC entity and a second communication link associated with the second RLC entity in accordance with a dual connectivity configuration, the report may indicate that the HFN desynchronization is associated with the first RLC entity, and reception of the message may be via the first communication link based on the HFN desynchronization being associated with the first RLC entity.

A method for wireless communications by a network entity is described. The method may include obtaining a report indicative of HFN desynchronization between a UE and the network entity and outputting a message indicative of a HFN associated with a PDU in response to obtaining the report, where the network entity ciphers the PDU based on the HFN.

A network entity for wireless communications is described. The network entity may include one or more memories storing processor executable code, and one or more processors coupled with the one or more memories. The one or more processors may individually or collectively be operable to execute the code to cause the network entity to obtain a report indicative of HFN desynchronization between a UE and the network entity and output a message indicative of a HFN associated with a PDU in response to obtaining the report, where the network entity ciphers the PDU based on the HFN.

Another network entity for wireless communications is described. The network entity may include means for obtaining a report indicative of HFN desynchronization between a UE and the network entity and means for outputting a message indicative of a HFN associated with a PDU in response to obtaining the report, where the network entity ciphers the PDU based on the HFN.

A non-transitory computer-readable medium storing code for wireless communications is described. The code may include instructions executable by one or more processors to obtain a report indicative of HFN desynchronization between a UE and the network entity and output a message indicative of a HFN associated with a PDU in response to obtaining the report, where the network entity ciphers the PDU based on the HFN.

In some examples of the method, network entities, and non-transitory computer-readable medium described herein, the message includes a control message and the method, apparatuses, and non-transitory computer-readable medium may include further operations, features, means, or instructions for transmitting, after the control message, the PDU.

In some examples of the method, network entities, and non-transitory computer-readable medium described herein, the control message includes a first field that indicates that a second field in the control message is indicative of the hyper-frame number.

In some examples of the method, network entities, and non-transitory computer-readable medium described herein, the control message indicates a value of the HFN via a quantity of bits in the second field.

In some examples of the method, network entities, and non-transitory computer-readable medium described herein, the message may be indicative of a count value, and the message being indicative of the HFN may be based on the count value being based on the HFN and an SN associated with the PDU.

In some examples of the method, network entities, and non-transitory computer-readable medium described herein, the message includes an indication that the message may be indicative of the count value.

In some examples of the method, network entities, and non-transitory computer-readable medium described herein, the message indicative of the count value is received based on satisfaction of one or more conditions.

In some examples of the method, network entities, and non-transitory computer-readable medium described herein, the one or more conditions includes a change in a value of the HFN.

In some examples of the method, network entities, and non-transitory computer-readable medium described herein, the one or more conditions includes transmission of a control message indicative of a change in structure of the message from a first structure to a second structure and the second structure supports an indication of the count value.

Some examples of the method, network entities, and non-transitory computer-readable medium described herein may further include operations, features, means, or instructions for transmitting configuration information indicative of the one or more conditions.

In some examples of the method, network entities, and non-transitory computer-readable medium described herein, either the report or a control message received from the UE may be indicative of one or more PDUs, including at least the PDU, missed by the UE based on the HFN desynchronization. In such cases, and the method, apparatuses, and non-transitory computer-readable medium may include further operations, features, means, or instructions for transmitting, after transmission of the message indicative of the HFN, the one or more PDUs missed by the UE, where the PDU may be a first received PDU of the one or more PDUs based on the message being indicative of the HFN associated with the PDU.

In some examples of the method, network entities, and non-transitory computer-readable medium described herein, the HFN desynchronization may be associated with a first RLC entity of one or more RLC entities associated with the network entity and the method, apparatuses, and non-transitory computer-readable medium may include further operations, features, means, or instructions for releasing a communication link associated with the first RLC entity based on reception of the report and re-establishing the communication link associated with the first RLC entity, where transmission of the message indicative of the HFN may be based on re-establishment of the communication link.

In some examples of the method, network entities, and non-transitory computer-readable medium described herein, each PDU of the one or more PDUs may be associated with a respective count value and the one or more PDUs may be received in ascending order of the respective count values.

In some examples of the method, network entities, and non-transitory computer-readable medium described herein, the HFN desynchronization may be associated with a first RLC entity of one or more RLC entities associated with the network entity and the method, apparatuses, and non-transitory computer-readable medium may include further operations, features, means, or instructions for transmitting, from the central unit to the distributed unit, an indication for the distributed unit to clear a buffer associated with the first RLC entity, where transmission of the one or more PDUs may be based on the buffer being cleared.

In some examples of the method, network entities, and non-transitory computer-readable medium described herein, the network entity may be associated with a first RLC entity and a second RLC entity, the first RLC entity may be associated with a first communication link, the second RLC entity may be associated with a second communication link, the report may indicate that the HFN desynchronization is associated with the first RLC entity, and transmission of the message may be via the first communication link based on the the HFN desynchronization being associated with the first RLC entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for hyper-frame number (HFN) resynchronization in accordance with one or more aspects of the present disclosure.

FIG. 2 shows an example of a network architecture that supports techniques for HFN resynchronization in accordance with one or more aspects of the present disclosure.

FIG. 3 shows an example of a wireless communications system that supports techniques for HFN resynchronization in accordance with one or more aspects of the present disclosure.

FIG. 4 shows an example of a wireless communications system that supports techniques for HFN resynchronization in accordance with one or more aspects of the present disclosure.

FIG. 5 shows an example of a wireless communications system that supports techniques for HFN resynchronization in accordance with one or more aspects of the present disclosure.

FIG. 6 shows an example of a process flow that supports techniques for HFN resynchronization in accordance with one or more aspects of the present disclosure.

FIGS. 7 and 8 show block diagrams of devices that support techniques for HFN resynchronization in accordance with one or more aspects of the present disclosure.

FIG. 9 shows a block diagram of a communications manager that supports techniques for HFN resynchronization in accordance with one or more aspects of the present disclosure.

FIG. 10 shows a diagram of a system including a device that supports techniques for HFN resynchronization in accordance with one or more aspects of the present disclosure.

FIGS. 11 and 12 show block diagrams of devices that support techniques for HFN resynchronization in accordance with one or more aspects of the present disclosure.

FIG. 13 shows a block diagram of a communications manager that supports techniques for HFN resynchronization in accordance with one or more aspects of the present disclosure.

FIG. 14 shows a diagram of a system including a device that supports techniques for HFN resynchronization in accordance with one or more aspects of the present disclosure.

FIGS. 15 and 16 show flowcharts illustrating methods that support techniques for HFN resynchronization in accordance with one or more aspects of the present disclosure.

### DETAILED DESCRIPTION

In some wireless communications systems, a network entity may transmit, to a user equipment (UE), packet data units (PDUs), indicative of data, in accordance with a packet data convergence protocol (PDCP), which may be referred to as PDCP data PDUs, where each PDCP data PDU is associated with a sequence number (SN) and a hyper-frame number (HFN). In such cases, each PDCP data PDU may include a header indicating a respective value of an SN associated with the PDCP data PDU, and a value of a respective HFN associated with each PDCP data PDU may be based on a count of SNs maintained by each device (e.g., each of the UE and the network entity). In other words, the network entity may increment values of SNs of subsequent PDCP data PDUs in a set of PDCP data PDUs and when a threshold (e.g., maximum) SN value is reached, a value of the HFN may increase by one for a next set of PDCP data PDUs. As such, each of the UE and the network entity may separately determine (e.g., track, count) a value of the HFN for each PDCP data PDU.

Additionally, each of the UE and the network entity may maintain a respective counter (e.g., COUNT, count value) associated with PDCP data PDUs, where a value of each counter for each PDCP data PDU is based on a value of the SN associated with the PDCP data PDU, as indicated via the PDCP data PDU, and a value of the HFN associated with the PDCP data PDU, as determined by a respective device (e.g., the UE or the network entity). However, in some cases, a value of a counter of the UE, which may be referred to as the UE counter (e.g., COUNT maintained by the UE), may differ from a value of a counter of the network entity, which may be referred to as the network entity counter (e.g., COUNT maintained by the network entity), for a same PDCP data PDU. The difference between the UE counter and the network entity counter may be based on a value of the HFN associated with the PDCP data PDU differing between the UE and the network entity, which may be referred to as HFN desynchronization. In such cases, the UE may not be able to decipher the PDCP data PDU based on the difference in values of the HFN. That is, ciphering of the PDCP data PDU by the network entity may be based on a value of the network entity counter and deciphering of the PDCP data PDU by the UE may be based on a value of the UE counter, such that when the value of the network entity counter used to cipher the PDCP data PDU differs from the value of the UE counter used to decipher the PDCP data PDU (e.g., due to HFN desynchronization), the UE may not be able to decipher the PDCP. In such cases, the UE may transmit a report indicative of HFN desynchronization to the network entity, such that the network entity may release one or more bearers associated with the HFN desynchronization and may re-establish the one or more bearer. However, releasing one or more bearers, may still result in a large service interruption time (e.g., service interruption time exceeding a threshold) and overhead.

Accordingly, techniques described herein may support HFN resynchronization (e.g., without releasing the one or more bearers) via transmission of an indication of an HFN to the UE. For example, in some cases, the network entity may transmit, based on reception of a report indicating HFN desynchronization, a PDCP control PDU, where the PDCP control PDU indicates an HFN of a next (e.g., upcoming) PDCP data PDU. Additionally, or alternatively, the network entity may transmit (e.g., occasionally, periodically) a PDCP data PDU indicating both an SN associated with the PDCP data PDU and an HFN associated with the PDCP data PDU. In other words, the PDCP data PDU may indicate a value of the network entity counter for the PDCP data PDU based on indicating both the SN and the HFN.

In some other cases, the network entity may include a central unit (CU) and a distributed unit (DU). In such cases, the network entity may support an HFN resynchronization procedure in which the CU may instruct, based on reception of a report indicating HFN desynchronization, the DU to release and re-establish a radio link control (RLC) entity associated with the HFN desynchronization, thereby emptying an RLC queue of the DU. Additionally, the network entity may transmit a PDCP control PDU indicating an HFN of a next (e.g., upcoming) PDCP data PDU and may transmit the next PDCP data PDU followed both one or more other PDCP data PDUs missed by the UE (e.g., as indicated in the report).

Aspects of the disclosure are initially described in the context of wireless communications systems. Aspects are then described in the context of a process flow. Aspects of the disclosure are further illustrated by and described with reference to apparatus diagrams, system diagrams, and flowcharts that relate to techniques for HFN resynchronization.

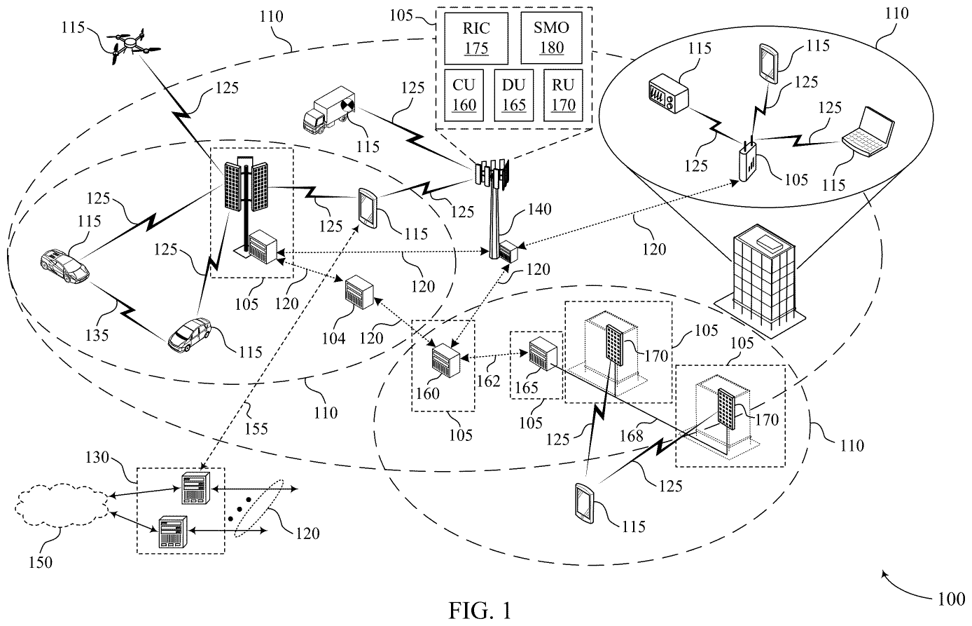

FIG. 1 shows an example of a wireless communications system 100 that supports techniques for HFN resynchronization in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU, such as a CU 160, a DU, such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), PDCP). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for HFN resynchronization as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, the wireless communications system 100 may support HFN resynchronization (e.g., without releasing the one or more bearers) via transmission of an indication of an HFN to a UE 115. For example, in some cases, a network entity 105 may transmit, to the UE 115 based on reception of a report indicating HFN desynchronization, a PDCP control PDU, where the PDCP control PDU indicates an HFN of a next (e.g., upcoming) PDCP data PDU. Additionally, or alternatively, the network entity may transmit, to the UE 115 (e.g., occasionally, periodically), a PDCP data PDU indicating both an SN associated with the PDCP data PDU and an HFN associated with the PDCP data PDU. In other words, the PDCP data PDU may indicate a value of the network entity counter for the PDCP data PDU based on indicating both the SN and the HFN.

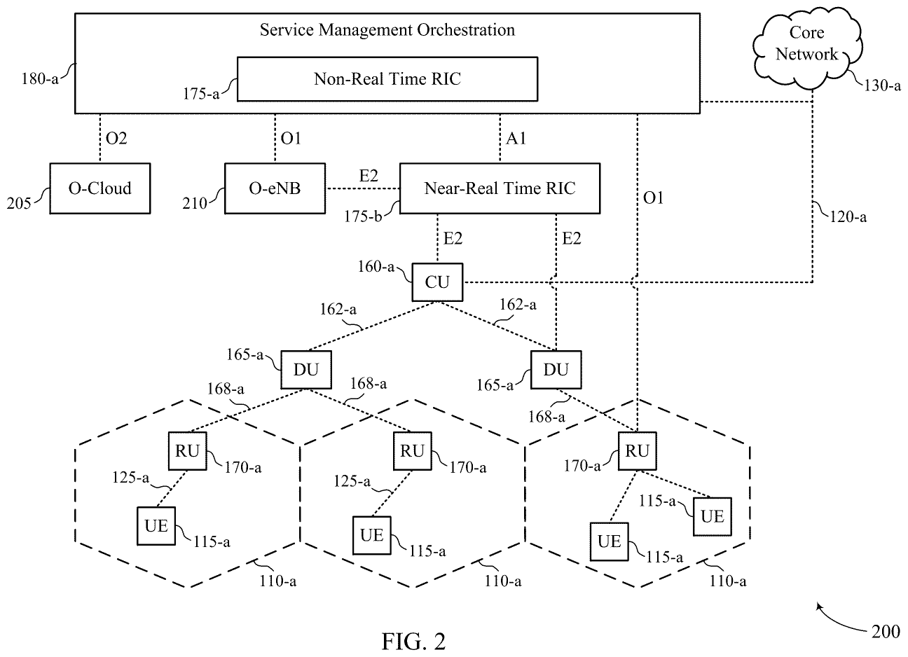

In some other cases, the network entity 105 may include a CU 160 and a DU 165, as described with reference to FIG. 2. In such cases, the network entity 105 may support an HFN resynchronization procedure in which the CU 160 may instruct, based on reception of a report indicating HFN desynchronization, the DU 165 to release and re-establish an RLC entity associated with the HFN desynchronization, thereby emptying an RLC queue of the DU 165. Additionally, the network entity 105 may transmit a PDCP control PDU indicating an HFN of a next (e.g., upcoming) PDCP data PDU and may transmit the next PDCP data PDU followed both one or more other PDCP data PDUs missed by the UE 115 (e.g., as indicated in the report).

FIG. 2 shows an example of a network architecture 200 (e.g., a disaggregated base station architecture, a disaggregated RAN architecture) that supports techniques for HFN resynchronization in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some cases, the network architecture 200 may support HFN resynchronization via transmission of an indication of an HFN to the UE 115-a. For example, as described herein, the network entity 105 may include a CU 160-a and a DU 165-a. In such cases, the network entity 105 may support an HFN resynchronization procedure in which the CU 160-a may instruct, based on reception of a report indicating HFN desynchronization, the DU 165-a to release and re-establish an RLC entity associated with the HFN desynchronization, thereby emptying an RLC queue of the DU 165-a. Additionally, the network entity 105 may transmit a PDCP control PDU indicating an HFN of a next (e.g., upcoming) PDCP data PDU and may transmit the next PDCP data PDU followed both one or more other PDCP data PDUs missed by the UE 115-a (e.g., as indicated in the report).

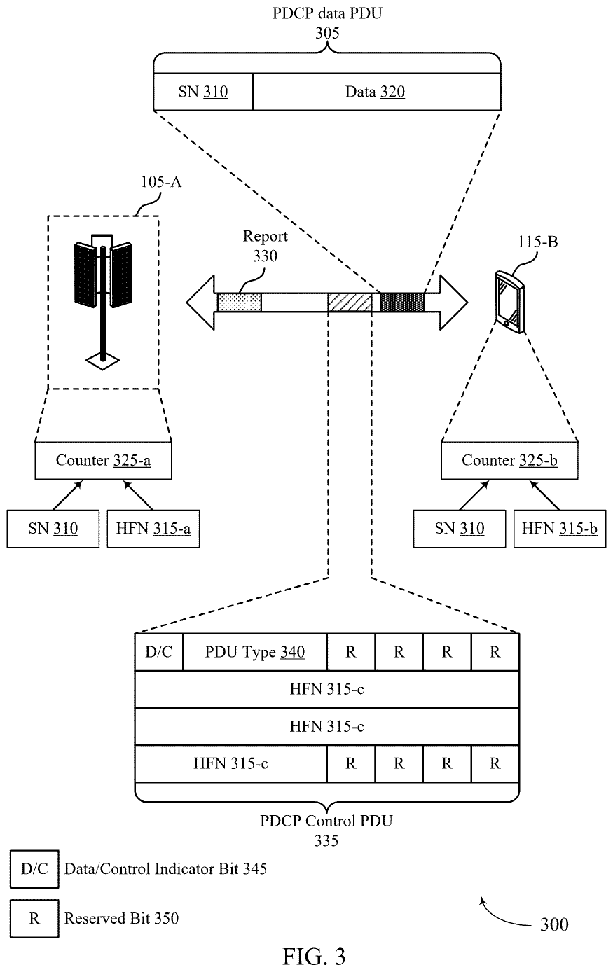

FIG. 3 shows an example of a wireless communications system 300 that supports techniques for HFN resynchronization in accordance with one or more aspects of the present disclosure. In some cases, the wireless communications system 300 may implement or be implemented by aspects of the wireless communications system 100, the network architecture 200, or both. For example, the wireless communications system 300 may include one or more UEs 115 (e.g., a UE 115-b) and one or more network entities 105 (e.g., a network entity 105-a), which may be examples of the corresponding devices as described herein.

In some wireless communications systems, such as the wireless communications system 300, a network entity 105, such as the network entity 105-a, may transmit, to a UE 115, such as the UE 115-b, PDUs in accordance with a PDCP, which may be referred to as PDCP PDUs 305, where each PDCP data PDU 305 is associated with an SN 310 (e.g., a value of an SN 310) and an HFN 315 (e.g., a value of an HFN 315). As described herein, the term “an SN 310” may refer to a value of an SN 310 and the term “an HFN 315” may refer to a value of an HFN 315. In such cases, each PDCP data PDU 305 may include a header indicating a respective SN 310 associated with the PDCP data PDU 305 (e.g., and may include data 320), and a value of a respective HFN 315 associated with each PDCP data PDU 305 may be based on a count of SNs 310 maintained by each device (e.g., each of the UE 115-b and the network entity 105-a). In other words, the network entity 105 may increment SNs 310 of subsequent PDCP PDUs 305 in a set of PDCP PDUs 305 and when a threshold (e.g., maximum) SN 310 is reached, an HFN 315 may increase by one for a next set of PDCP PDUs 305. For example, each PDCP data PDU 305 in a first set of PDCP PDUs 305 may be associated with an HFN 315 of 1 and respective SNs 310 of PDCP PDUs 305 in the first set of PDCP PDUs 305 may increment from 000 (e.g., for a first PDCP data PDU 305 in the first set of PDCP PDUs 305) to 111 (e.g., for a last PDCP data PDU 305 in the first set of PDCP PDUs 305). Thus, after the SN 310 of 111 is used (e.g., after the last PDCP data PDU 305 in the first set of PDCP data PDU 305), the HFN 315 may increase from 1 to 2 for a second set of PDCP PDUs 305 and respective SNs 310 for the second set of PDCP PDUs 305 may reset (e.g., begin) incrementing from 000. As such, each of the UE 115-b and the network entity 105-a may separately determine (e.g., track, count) the HFN 315 for each PDCP data PDU 305.

Additionally, each of the UE 115-b and the network entity 105-a may maintain a respective counter 325 (e.g., COUNT) associated with PDCP PDUs 305, where a value of each counter 325 for each PDCP data PDU 305 is based on the SN 310 associated with the PDCP data PDU 305 (e.g., as indicated via the PDCP data PDU 305) and the HFN 315 associated with the PDCP data PDU 305 (e.g., as determined by each device). However, in some cases, a value of a counter 325 of the UE 115-b, or a counter 325-b (e.g., UE counter), may differ from a value of a counter 325 of the network entity 105-a, or a counter 325-a (e.g., network entity counter), for a same PDCP data PDU 305 based on the HFN 315 associated with the PDCP data PDU 305 differing between the UE 115-b and the network entity 105-a.

For example, as depicted in FIG. 3, the network entity 105-a may transmit a PDCP data PDU 305 (e.g., PDCP data PDU 305) to the UE 115-b, where the PDCP data PDU 305 indicates at least the SN 310 and data 320. As such, a value of the counter 325-a for the PDCP data PDU 305 may be based on the SN 310 and an HFN 315-a associated with the PDCP data PDU 305, as identified by the network entity 105-a. However, a value of the counter 325-b for the PDCP data PDU 305 may be based on the SN 310 and an HFN 315-b, as determined by the UE 115-b, where the HFN 315-a is different than the HFN 315-b. In other words, the value of the counter 325-a may be different than the value of the counter 325-b based on the network entity 105-a and the UE 115-b determining different HFNs 315 for the same PDCP data PDU 305, which may be referred to as HFN desynchronization (e.g., based on the HFN 315-a being different than the HFN 315-b).

In such cases, the UE 115-b may not be able to decipher the PDCP data PDU 305 (e.g., without integrity protection, with integrity protection) based on the HFN 315-a being different than the HFN 315-b (e.g., based on the value of the counter 325-a being different than the value of the counter 325-b). That is, ciphering of the PDCP data PDU 305 by the network entity 105-a may be based on the value of the counter 325-a and deciphering of the PDCP data PDU 305 by the UE 115-b may be based on the value of the counter 325-b, such that when the value of the counter 325-a differs from the value of the counter 325-b based on HFN desynchronization, the deciphering by the UE 115-b may fail. In some cases, the UE 115-b may detect HFN desynchronization based on failure to decipher the PDCP data PDU 305. That is, verification of an HFN 315 (e.g., by the UE 115-b) may include deciphering an associated PDCP data PDU 305 with a candidate key, where the candidate key is based on an associated HFN 315, and verifying a first byte in the PDCP data PDU 305 (e.g., an IP header), such that when deciphering fails (e.g., based on using a candidate key that is based on a different HFN 315 than used by the network entity 105-a to cipher the PDCP data PDU 305), the UE 115-b may not be able to verify the first byte. In such cases, the UE 115-b may discard the PDCP data PDU 305.

Additionally, the network entity 105-a may not be aware of HFN desynchronization, such that the network entity 105-a may continue to send PDCP PDUs 305 that the UE 115-b may not be able to successfully decipher and may continue to discard, resulting in service interruptions. That is, data 320 (e.g., from each PDCP data PDU 305) may be discarded by the UE 115-b (e.g., by a modem of the UE 115-b) and may not be copied to a host (e.g., of the UE 115-b), such that the UE 115-b may not be able to recover the data 320 after discarding (e.g., such that the data 320 is lost for an application). For example, in some cases (e.g., at high downlink rates), a demback at the UE 115-b may perform processing of a PDCP data PDU 305 and may write ciphertext to an IP accelerator (e.g., of the UE 115-b) without writing a copy of the ciphertext to the modem of the UE 115-b. However, as previously mentioned, if deciphering fails at the IP accelerator, the PDCP data PDU 305 may be discarded by the IP accelerator without an ability to retry deciphering (e.g., due to no copy of the ciphertext at the modem).

In some cases, to resolve HFN desynchronization, the demback at the UE 115-b may process the PDCP data PDU 305 and may write ciphertext to the modem, the modem may copy the ciphertext, and may write the ciphertext and a first candidate key, based on a first HFN 315, to the IP accelerator. In such cases, if deciphering fails, the IP accelerator may indicate the failure to the modem and the modem may write the ciphertext and a second candidate key based on a second HFN 315 to the IP accelerator, where the second HFN 315 is 1 greater or 1 less than the first HFN 315. If deciphering is successful based on the second HFN 315, the IP accelerator may indicate the success to the modem and the modem may delete the copy of the ciphertext. Additionally, the IP accelerator many write plain text to the host. In some other cases, if deciphering fails again, the IP accelerator may indicate the failure to the modem and the modem may write the ciphertext and a third candidate key based on a third HFN 315 to the IP accelerator, where the third HFN 315 is 1 greater than the first HFN 315 if the second HFN 315 was 1 less than the first HFN 315, or is 1 less than the first HFN 315 if the second HFN 315 was 1 greater than the first HFN 315. However, this may result in increased latency due to multiple deciphering attempts, resulting in service interruptions. Additionally, or alternatively, if deciphering using the first HFN 315, the second HFN 315, and the third HFN 315 fails, the UE 115-b may be unable to resolve the HFN desynchronization.

In some other cases, to resolve HFN desynchronization, the UE 115-b may release a connection (e.g., RRC connection) with the network entity 105-a to reset the counter 325-a and the counter 325-b. However, releasing the connection may result in high interruption time (e.g., interruption time exceeding a threshold interruption time), disruption to multiple bearers (e.g., all bearers) supported by the UE 115-b when the HFN desynchronization may be associated with a single bearer (e.g., of the multiple bearers), and overhead associated with connection re-establishment (e.g., RRC re-establishment).

As such, in some cases, the UE 115-b may transmit, to the network entity 105-a, a report 330 indicating HFN desynchronization based on satisfaction of one or more trigger events associated with HFN desynchronization (e.g., configured by the network entity 105-a). Transmission of the report 330 may enable the network entity 105-a to correct HFN desynchronization via PDCP re-establishment. That is, the network entity 105-a may release one or more bearers associated with the HFN desynchronization (e.g., as indicated via the report 330) and may re-establish (e.g., re-add) the one or more bearers (e.g., to reset a candidate key without performing an RRC release procedure, which may result in more interruption time and overhead as compared to releasing the bearer, or the multiple bearers). However, releasing the one or more bearers may still result in a large service interruption time (e.g., service interruption time exceeding a threshold) and increase overhead (e.g., RRC overhead).

Accordingly, techniques described herein may support HFN resynchronization via transmission of an indication of an HFN to the UE 115-b. For example, in some cases (e.g., no dual connectivity, no CU-DU split), the UE 115-b may detect HFN desynchronization and may transmit, to the network entity 105-a, a report 330 indicative of HFN desynchronization (e.g., based on one or more trigger events associated with HFN desynchronization). As such, the network entity 105-a may transmit, to the UE 115-b in response to the report 330, a PDCP control PDU 335 indicating an HFN 315-c associated with a current (e.g., upcoming, next) PDCP data PDU 305 (e.g., transmission). That is, the network entity 105-a may be aware of (e.g., know) the HFN 315-c associated with a next PDCP data PDU 305 to be received by the UE 115-b (e.g., simultaneously with the PDCP control PDU 335 or after the PDCP control PDU 335), such that the network entity 105-a may transmit an indication of the HFN 315-c to the UE 115-b.

In such cases, the PDCP control PDU 335 (e.g., HFN control PDU) may include a data/control indicator bit 345 indicating that the PDCP control PDU 335 is a control PDU. In other words, a value of 0 of the data/control indicator bit 345 may indicate that a PDU is a PDCP data PDU 305 and a value of 1 of the data/control indicator bit 345 may indicate that a PDU is a PDCP control PDU 335. Additionally, the PDCP control PDU 335 may include a first set of bits (e.g., 3 bits) indicating a PDU type 340 associated with the PDCP control PDU 335. For example, a first value of the first set of bits (e.g., 000) may indicate that the PDCP control PDU 335 is associated with a first PDU type 340, a second value of the first set of bits (e.g., 001) may indicate that the PDCP control PDU 335 is associated with a second PDU type 340, and a third value of the first set of bits (e.g., 010) may indicate that the PDCP control PDU 335 is associated with a third PDU type 340. In some cases, the first PDU type 340 may indicate that the PDCP control PDU 335 includes (e.g., is indicative of) a PDCP status report, the second PDU type 340 may indicate that the PDCP control PDU 335 includes interspersed robust header compression (ROHC) feedback, and the third PDU type 340 may indicate that the PDCP control PDU 335 includes an indication of the HFN 315-c. The PDCP control PDU 335 may additionally include one or more reserved bits 350, as well as a second set of bits (e.g., 14 or 20 bits) indicating the HFN 315-c. As such, the UE 115-b may apply the HFN 315-c (e.g., new HFN 315) to the next PDCP data PDU 305 received after the PDCP control PDU 335.

In some cases, the network entity 105-a may not cipher the PDCP control PDU 305 (e.g., in 5G-NR). In some other cases, the network entity 105-a may cipher the PDCP control PDU 305 (e.g., when communicated over the air (OTA)). In such cases, the network entity 105-a may cipher the PDCP control PDU 305 at a PDCP layer (e.g., using PDCP ciphering) or at a MAC layer (e.g., using MAC ciphering). Additionally, or alternatively, (e.g., because of no CU-DU split), the network entity 105-a may be capable of prioritizing the PDCP control PDU 335 (e.g., carrying the indication of the HFN 315-c) over other queued data 320 (e.g., RLC data 320), if any. That is, the network entity 105-a may transmit the PDCP control PDU 335 after receiving the report 330 and before transmitting any additional PDCP data PDUs 305, to avoid the additional PDCP data PDUs 305 being discarded by the UE 115-b (e.g., due to failure to decipher the additional PDCP data PDUs 305).

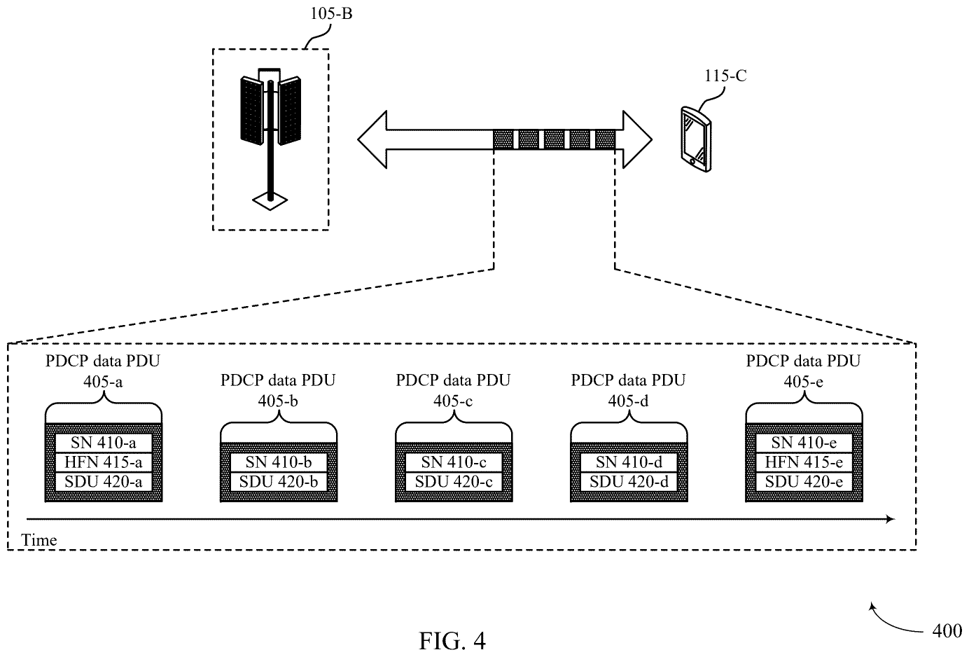

FIG. 4 shows an example of a wireless communications system 400 that supports techniques for HFN resynchronization in accordance with one or more aspects of the present disclosure. In some cases, the wireless communications system 400 may implement or be implemented by aspects of the wireless communications system 100, the network architecture 200, the wireless communications system 300, or any combination thereof. For example, the wireless communications system 400 may include one or more UEs 115 (e.g., a UE 115-c) and one or more network entities 105 (e.g., a network entity 105-b), which may be examples of the corresponding devices as described herein.

As described herein, in some cases, a network entity 105 may transmit a PDCP control PDU indicating an HFN 415 (e.g., via 14 or 20 bits). In some other cases, as described with reference to FIG. 4, a network entity 105, such as the network entity 105-b, may transmit, to a UE 115, such as the UE 115-c, an indication of a value of a counter (e.g., total PDCP COUNT) of the network entity 105-b, which may be referred to as the network entity counter. For example, the network entity 105-b may occasionally interject (e.g., include) an indication of an HFN 415 into a header of a PDCP data PDU 405, such that the header of the PDCP data PDU 405 indicates the value of the network entity counter (e.g., total PDCP counter). In other words, as described herein, the value of the network entity counter (e.g., associated with the PDCP data PDU 405) may be based on the HFN 415 (e.g., as determined by the network entity 105-b) and an SN 410 indicated via the PDCP data PDU 405 (e.g., via the header of the PDCP data PDU 405), such that the header of the PDCP data PDU 405 may indicate the value of the network entity counter based on the header of the PDCP data PDU 405 indicating the HFN 415 and the SN 410 associated with the PDCP data PDU 405. In such cases, overhead associated with indicating the HFN 415 may be below a threshold (e.g., may be acceptable) due to PDCP concatenation.

For example, as depicted in FIG. 4, the network entity 105-b may transmit a PDCP data PDU 405-a indicating an SN 410-a (e.g., SN #0), an HFN 415-a (e.g., HFN #M+1), and an SDU 420-a (e.g., SDU #N+1). However, a next three PDCP data PDUs 405 may not indicate a respective HFN 415 associated with each PDCP data PDU 405. That is, the network entity 105-b may transmit a PDCP data PDU 405-b indicating an SN 410-b (e.g., SN #N) and an SDU 420-b (e.g., SDU #N), a PDCP data PDU 405-c indicating an SN 410-c (e.g., SN #3) and an SDU 420-c (e.g., SDU #3), and a PDCP data PDU 405-d indicating an SN 410-d (e.g., SN #2) and an SDU 420-d (e.g., SDU #2). As such, each of the network entity 105-b and the UE 115-c may independently determine an HFN 415-b associated with the PDCP data PDU 405-b, an HFN 415-c associated with the PDCP data PDU 405-c, and an HFN 415-d associated with the PDCP data PDU 405-d. However, a next PDCP data PDU 405 after the PDCP data PDU 405-d may indicate a respective HFN 415. That is, the network entity 105-b may transmit a PDCP data PDU 405-e indicating an SN 410-e (e.g., SN #1), an HFN 415-e (e.g., HFN #M), and an SDU 420-e (e.g., SDU #1). Thus, even if the UE 115-c detects HFN desynchronization based on the PDCP data PDU 405-b, the PDCP data PDU 405-c, the PDCP data PDU 405-d, or any combination thereof, the UE 115-c may be capable of resynchronizing HFN for the PDCP data PDU 405-e based on the PDCP data PDU 405-e indicating the HFN 415-e.

In some cases, network entity 105-b may transmit a PDCP data PDU 405 indicating an associated HFN 415 (e.g., an HFN 415 associated with an SDU 420 included in the PDCP data PDU 405) dynamically, semi-statically (e.g., via configuration), statically, or any combination thereof. For example, in some cases, the network entity 105-b may dynamically transmit a PDCP data PDU 405 indicating an associated HFN 415, where a header (e.g., extended header) of the PDCP data PDU 405 indicates whether the PDCP data PDU 405 includes an indication of the associated HFN 415. That is, a PDCP data PDU 405 without an indication of an associated HFN 415, such as the PDCP data PDU 405-b, may include a first header (e.g., main header), while a PDCP data PDU 405 with an indication of an associated HFN 415, such as the PDCP data PDU 405-e, may include the first header and a second header (e.g., extension header), where the second header indicates that the PDCP data PDU 405-e includes the indication of the HFN 415-e (e.g., IPV6 architecture with main header and optional extension headers). Additionally, or alternatively, each (e.g., all) PDCP data PDU 405 may include one or more HFN indicator bits (e.g., in a respective header of each PDCP data PDU 405), where a first value (e.g., 0) of the one or more HFN indicator bits may indicate a respective PDCP data PDU 405 does not include an indication of an associated HFN 415 and a second value (e.g., 1) of the one or more HFN indicator bits may indicate the respective PDCP data PDU 405 includes indication of the associated HFN 415.

Additionally, or alternatively, the network entity 105-b may semi-statically or statically transmit a PDCP data PDU 405 indicating an associated HFN 415. In such cases, the network entity 105-b may transmit (e.g., during configuration of one or more bearers) configuration information (e.g., RRC signaling) indicating, to the UE 115-c, when a header of a PDCP data PDU 405 includes an indication of an associated HFN 415 (e.g., for the one or more bearers). For example, the configuration information may indicate one or more conditions associated with transmission of a PDCP data PDU 405 indicating an associated HFN 415, such that the network entity 105-b may transmit (e.g., and the UE 115-c may expect) the PDCP data PDU 405 indicating the associated HFN 415 based on satisfaction of at least a subset of the one or more conditions. In some cases (e.g., statically), the one or more conditions may include an HFN 415 changing. For example, the HFN 415-b, the HFN 415-c, and the HFN 415-d may be the same but the HFN 415-e may be different than the HFN 415-d, such that the PDCP data PDU 405-e may indicate the HFN 415-e based on the HFN 415-e being different than (e.g., changing from) the HFN 415-d.

Additionally, or alternatively, (e.g., semi-statically), the one or more conditions may include a structure of a PDCP data PDU 405 changing (e.g., from a first structure to a second structure). That is, the network entity 105-b may transmit, to the UE 115-c, a control message (e.g., MAC-CE message) switching (e.g., indicating a switch of) a header structure of PDCP data PDUs 405 from the first structure, associated with a header of the PDCP data PDUs 405 indicating respective SNs 410, to a second structure, associated with the headers of the PDCP data PDUs 405 indicating both the respective SNs 410 and respective HFNs 415 (e.g., indicating a total COUNT, based on a data rate). Thus, the network entity 105-b may transmit (e.g., and the UE 115-c may expect) a PDCP data PDU 405 indicating an associated HFN 415 based on (e.g., after) transmission of the control message indicating the switch to the second structure.

In some cases, the network entity 105-b may transmit a PDCP data PDU 405 indicating an associated HFN 415 based on receiving, from the UE 115-c, a report indicative of HFN desynchronization. For example, the network entity 105-b may dynamically transmit the PDCP data PDU 405 indicating the associated HFN 415 based on receiving the report indicative of HFN desynchronization. In another example, the one or more conditions (e.g., configured by the network entity 105-b) may include transmission of the report indicative of the HFN synchronization, such that the UE 115-c may expect to receive (e.g., and may receive) the PDCP data PDU 405 indicating the associated HFN 415 after (e.g., based on) transmission of the report. In some other cases, the network entity 105-b may transmit the PDCP data PDU 405 indicating the associated HFN 415 regardless of whether the network entity 105-b receives the report indicating HFN desynchronization from the UE 115-c.

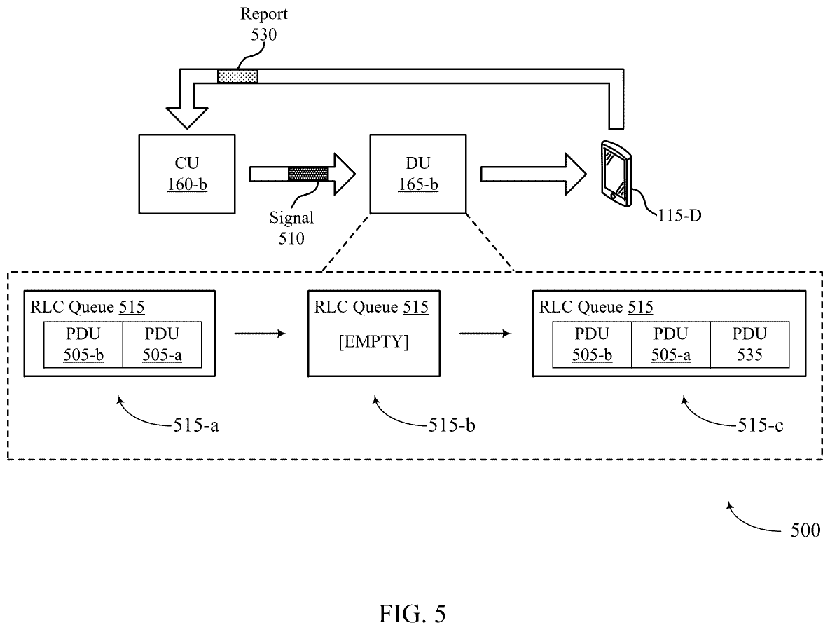

FIG. 5 shows an example of a wireless communications system 500 that supports techniques for HFN resynchronization in accordance with one or more aspects of the present disclosure. In some cases, the wireless communications system 500 may implement or be implemented by aspects of the wireless communications system 100, the network architecture 200, the wireless communications system 300, the wireless communications system 400, or any combination thereof. For example, the wireless communications system 500 may include one or more UEs 115 (e.g., a UE 115-d) and one or more network entities 105 (e.g., a network entity 105-c), which may be examples of the corresponding devices as described herein.

In some cases, as described with reference to FIG. 2, a network entity 105-c, such as the network entity 105-c (e.g., not depicted), may include a CU 160-b and a DU 165-b (e.g., support a CU-DU split). In such cases, indicating an HFN to the UE 115-d (e.g., by the network entity 105-c) may be associated with one or more challenges. For example, the DU 165-b may include (e.g., be associated with) an RLC queue 515 (e.g., which may get large, may exceed a threshold size). As such, when the UE 115-d transmits, to the CU 160-b, a report 530 indicative of HFN desynchronization, the CU 160-b may not know an HFN of a next PDCP data PDU 505 to be sent (e.g., intended to be sent) by the DU 165-b (e.g., from the RLC queue 515). Additionally, or alternatively, even if the CU 160-b knows the HFN of the next PDCP data PDU 505 and generates a PDCP control PDU 535 indicating the HFN, the PDCP control PDU 535 may not be prioritized in the RLC queue 515, such that the PDCP control PDU 535 may be transmitted after (e.g., may be blocked behind) other queued traffic in the RLC queue 515. Thus, the HFN may not be applicable (e.g., may not be correct) by the time the PDCP control PDU 535 is transmitted.

As such, in some cases, the network entity 105-c and the UE 115-d may support an HFN resynchronization procedure (e.g., data recover with HFN resynchronization procedure). In such cases, the CU 160-b may determine (e.g., identify) one or more PDCP data PDUs 505 missed by the UE 115-d due to HFN desynchronization. In some cases, the report 530 may indicate the one or more PDCP data PDUs 505 missed by the UE 115-d, such that the CU 160-b determines the one or more PDCP data PDUs 505 missed by the UE 115-d based on reception of the report 530. As such, the CU 160-b may transmit, to the DU 165-b based on reception of the report 530 (e.g., via F1 signaling), instructions for the DU 165-b to release and re-establish an RLC, thereby clearing the RLC queue 515 (e.g., RLC buffer). Thus, after clearing the RLC queue 515, the network entity 105-c may transmit (e.g., the CU 160-b may generate and the DU 165-b may transmit), a PDCP control PDU 535 (e.g., an HFN resynchronization control PDU) indicating an HFN of a next PDCP data PDU 505 (e.g., a first PDCP data PDU 505 of the one or more missed PDCP data PDUs 505).

Additionally, after transmission of the PDCP control PDU 535, the network entity 105-c may transmit the one or more missed PDCP data PDUs 505, starting with the next PDCP data PDU 505 associated with the HFN indicated via the PDCP control PDU 535. In such cases, the network entity 105-c may transmit the one or more missed PDCP data PDUs 505 in ascending order of COUNT value. That is, each of the one or more missed PDCP data PDUs 505 may be associated with a value of a network entity counter (e.g., a counter of the network entity 105-c), which may be referred to as a COUNT value of the network entity counter, such that the network entity 105-c may transmit the one or more missed PDCP data PDUs 505 starting with a missed PDCP data PDU 505 (e.g., of the one or more missed PDCP data PDUs 505) associated with a smallest COUNT value, followed by other missed PDCP data PDUs (e.g., of the one or more missed PDCP data PDUs 505) in ascending order of COUNT value.

For example, at 515-a, the RLC queue 515 may include a PDCP data PDU 505-a associated with a COUNT value of 10 and a PDCP data PDU 505-b associated with a count value of 11. As such, the DU 165-b may transmit the PDCP data PDU 505-a and the PDCP data PDU 505-b to the UE 115-d. However, the UE 115-d may detect HFN desynchronization and may fail to decipher the PDCP data PDU 505-a and the PDCP data PDU 505-b. Thus, the UE 115-d may transmit a report 530 indicating HFN desynchronization and indicating the UE 115-d missed (e.g., failed to decipher) the PDCP data PDU 505-a and the PDCP data PDU 505-b. The CU 160-b may transmit, to the DU 165-b, a signal 510 instructing the DU 165-b to release and re-establish an RLC, thereby clearing the RLC queue 515 at 515-b. Additionally, the CU 160-b may generate a PDCP control PDU 535 indicating an HFN associated with the PDCP data PDU 505-a, such that, at 515-c, the RLC queue 515 may include the PDCP control PDU 535 followed by the PDCP data PDU 505-a and the PDCP data PDU 505-b, missed by the UE 115-d, for transmission to the UE 115-d.

In some other cases, rather than the CU 160-b transmitting, to the DU 165-b, instructions to release and re-establish the RLC, the signal 510 (e.g., transmitted by the CU 160-b via F1 signaling) may indicate for the DU 165-b to clear the RLC queue 515 (e.g., and a MAC buffer, without releasing and re-establishing the RLC). In such cases, after clearing the RLC queue 515, the network entity 105-c may transmit a PDCP control PDU 535 followed by one or more missed PDCP data PDUs 505, as described herein. Additionally, or alternatively, the HFN resynchronization procedure may be part of an intra-cell or inter-cell handover procedure (e.g., to correct HFN desynchronization).

In some cases, as described with reference to FIGS. 3, 4, and 5, the UE 115-a may support a dual connectivity configuration. In other words, the network entity 105-a may be associated with a first RLC entity and a second RLC entity, such that the UE 115-a may support a first communication link with the first RLC entity and a second communication link with the second RLC entity. In such cases, the UE 115-a may support detection and reporting of HFN desynchronization separately for each RLC entity (e.g., separately per leg). Thus, in some cases, the UE 115-d may transmit a report 530 indicating HFN desynchronization associated with a single communication link, such as the first communication link. In such cases, the network entity 105-c may deactivate the first communication link or may perform HFN resynchronization for the first communication link in accordance with techniques described herein (e.g., using the HFN resynchronization procedure, as discussed with reference to FIG. 5).

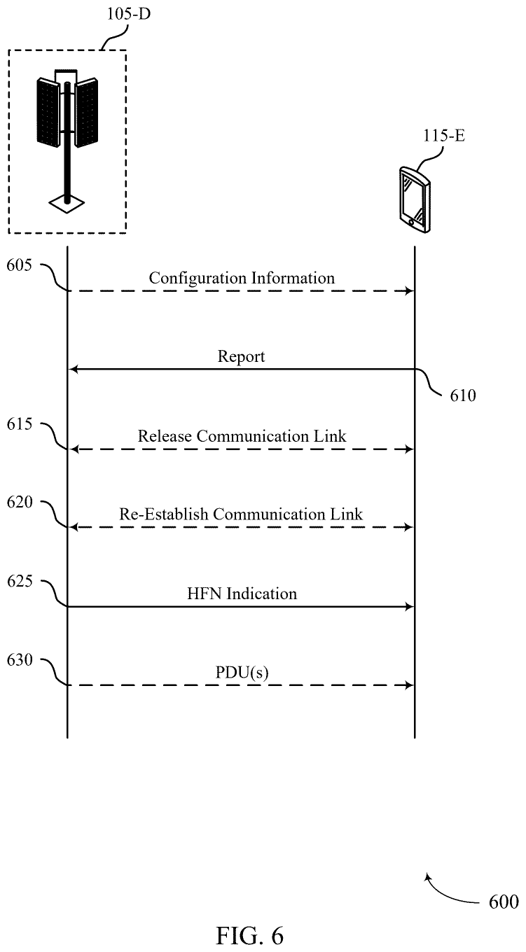

FIG. 6 shows an example of a process flow 600 that supports techniques for HFN resynchronization in accordance with one or more aspects of the present disclosure. In some cases, the process flow 600 may implement or be implemented by aspects of the wireless communications system 100, the network architecture 200, the wireless communications system 300, the wireless communications system 400, the wireless communications system 500, or any combination thereof. For example, the process flow 600 may include one or more UEs 115 (e.g., a UE 115-e) and one or more network entities 105 (e.g., a network entity 105-d), which may be examples of the corresponding devices as described herein. In the following description of the process flow 600, the operations between the UE 115-e and the network entity 105-d may be communicated in a different order than the example order shown, or the operations performed by the UE 115-e and the network entity 105-d may be performed in different orders or at different times. Some operations may also be omitted from the process flow 600, and other operations may be added to the process flow 600.

In some cases, at 605, the UE 115-e may receive, from the network entity 105-d, configuration information indicating one or more conditions associated with indicating HFN. In some cases, the one or more conditions may include a change in a value of an HFN, reception of a control message indicating a change in a structure of a message (e.g., indicative of the HFN) from a first structure to a second structure, where the second structure supports an indication of a count value, or both.

At 610, the UE 115-e may transmit, to the network entity 105-d, a report indicative of HFN desynchronization between the UE 115-e and the network entity 105-d (e.g., based on satisfaction of one or more trigger events).

In some cases, the HFN desynchronization may be associated with a first RLC entity. As such, at 615, the UE 115-e may release a first communication link associated with the first RLC entity based on transmission of the report. Additionally, at 620, the UE 115-e may re-establish the first communication link with the first RLC.

At 625, the UE 115-e may receive, from the network entity 105-d based on transmission of the report (e.g., and based on re-establishment of the communication link), the message indicative of the HFN associated with a PDU (e.g., PDCP data PDU). In some cases, the message may be a control message. In such cases, the control message may include one or more bits in a first field indicating that a second field in the control message is indicative of the HFN number. Additionally, or alternatively, the control message may indicate the HFN number via a quantity of bits (e.g., 15 or 20 bits) in the second field.

In some other cases, the message may be the PDU and the PDU may indicate the count value (e.g., total COUNT value), where the message being indicative of the HFN is on the value of the counter being based on the HFN and a SN associated with the PDU. For example, in some cases, the PDU may indicate both the HFN and the SN associated with the PDU (e.g., rather than just the SN), such that the PDU indicates the count value based on indicating both the HFN and the SN. In some other cases, the PDU may indicate the count value and the SN, such that the UE 115-e may determine the HFN based on the count value and the SN. In either cases, the PDU may include an indication that the PDU is indicative of the value count value. In some cases, the PDU may indicate the count valuebased on satisfaction of the one or more conditions.

In some cases, the network entity 105-d may be associated with the first RLC entity and a second RLC entity, where the UE 115-e supports the first communication link associated with the first RLC entity and a second communication link associated with the second RLC entity in accordance with a dual connectivity configuration. In such cases, the report may indicate that the HFN descynchronization is associated with the first RLC entity and reception of the message may be via the first communication link based on the HFN desynchronization being associated with the first RLC entity.

As such, at 630, the UE 115-e may receive one or more PDUs. In some cases, when the message is a control message, the UE 115-e may receive, after the control message, the PDU. Thus, the UE 115-e may decipher the PDU based on the indicated HFN.

Additionally, or alternatively, the report or a control message transmitted by the UE 115-e may be indicative of one or more PDUs, including at least the PDU, missed by the UE 115-e based on the HFN desynchronization. As such, at 630, the UE 115-e may receive, after reception of the message indicative of the HFN, the one or more PDUs missed by the UE 115-e, where the PDU is a first received PDU of the one or more PDUs based on the message being indicative of the HFN associated with the PDU. In some cases, each PDU of the one or more PDUs may be associated with a respective value of the counter, where the one or more PDUs are received in ascending order of the respective count values.

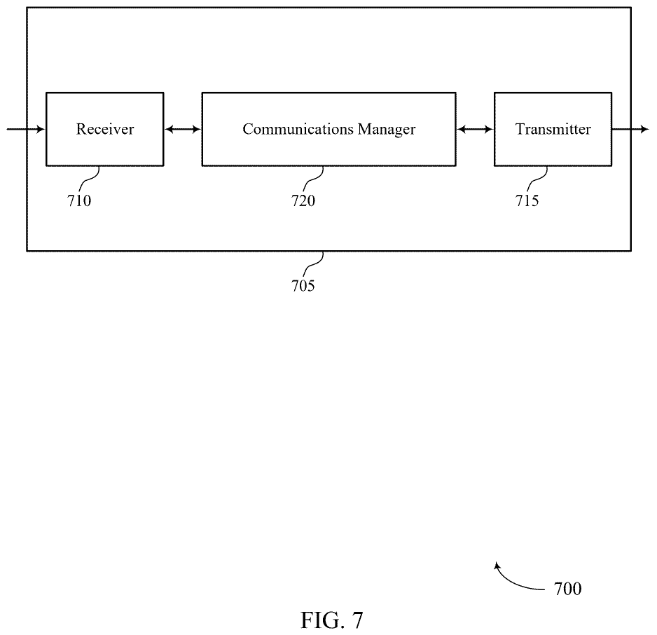

FIG. 7 shows a block diagram 700 of a device 705 that supports techniques for HFN resynchronization in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for HFN resynchronization). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for HFN resynchronization). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for HFN resynchronization as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting a report indicative of HFN desynchronization between the UE and a network entity. The communications manager 720 is capable of, configured to, or operable to support a means for receiving a message indicative of a HFN associated with a PDU based on transmission of the report, where the UE deciphers the PDU based on the HFN.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for HFN resynchronization, which may result in reduced processing, reduced power consumption, and more efficient utilization of communication resources, among other advantages.

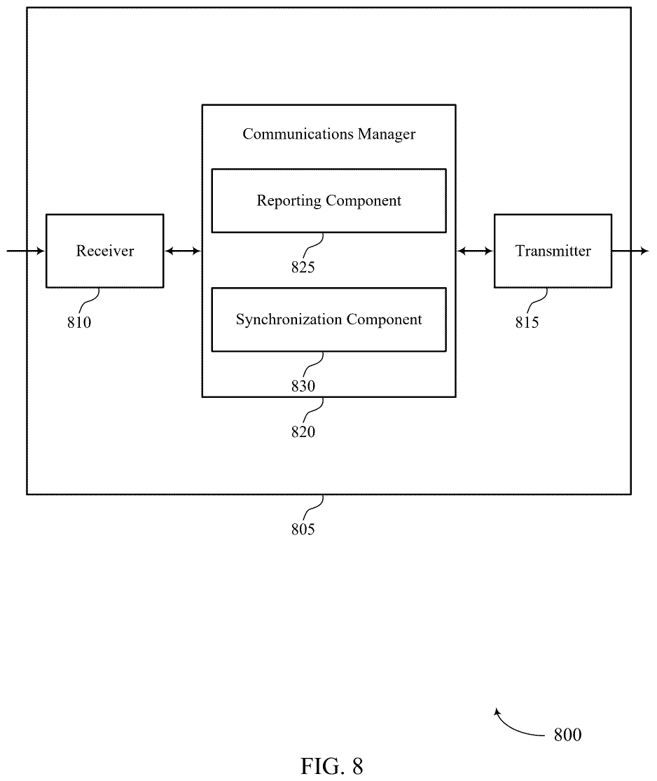

FIG. 8 shows a block diagram 800 of a device 805 that supports techniques for HFN resynchronization in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for HFN resynchronization). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for HFN resynchronization). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for HFN resynchronization as described herein. For example, the communications manager 820 may include a reporting component 825 a synchronization component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The reporting component 825 is capable of, configured to, or operable to support a means for transmitting a report indicative of HFN desynchronization between the UE and a network entity. The synchronization component 830 is capable of, configured to, or operable to support a means for receiving a message indicative of a HFN associated with a PDU based on transmission of the report, where the UE deciphers the PDU based on the HFN.

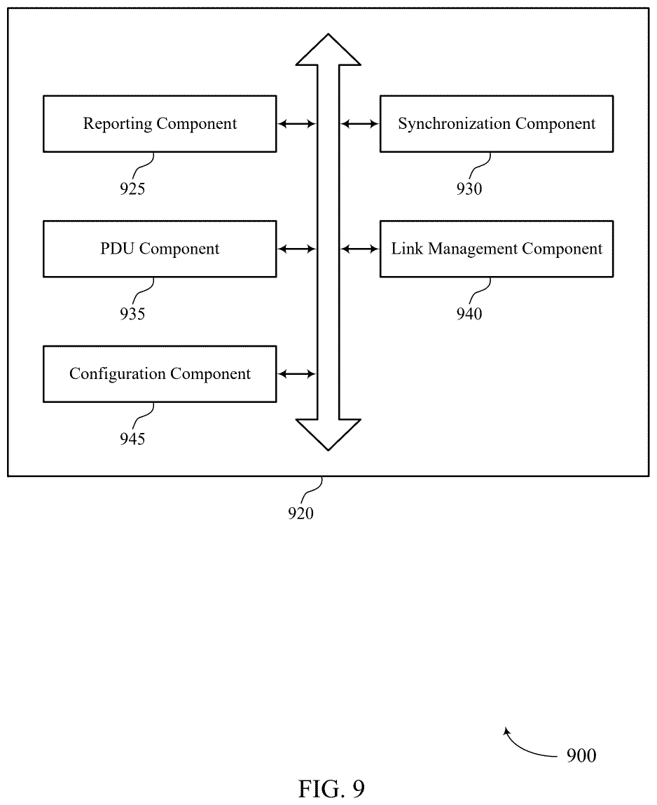

FIG. 9 shows a block diagram 900 of a communications manager 920 that supports techniques for HFN resynchronization in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for HFN resynchronization as described herein. For example, the communications manager 920 may include a reporting component 925, a synchronization component 930, a PDU component 935, a link management component 940, a configuration component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The reporting component 925 is capable of, configured to, or operable to support a means for transmitting a report indicative of HFN desynchronization between the UE and a network entity. The synchronization component 930 is capable of, configured to, or operable to support a means for receiving a message indicative of a HFN associated with a PDU based on transmission of the report, where the UE deciphers the PDU based on the HFN.

In some examples, the message includes a control message, and the PDU component 935 is capable of, configured to, or operable to support a means for receiving, after the control message, the PDU.

In some examples, the control message comprises a first field that indicates that a second field in the control message is indicative of the HFN.

In some examples, the control message indicates a value of the HFN via a quantity of bits in the second field.

In some examples, the message is indicative of a count value, and the message being indicative of the HFN is based on the count value being based on the part on the HFN and an SN associated with the packet data.

In some examples, the message includes an indication that the message is indicative of the count value.

In some examples, the message indicative of the count value is received based on satisfaction of one or more conditions.

In some examples, the one or more conditions includes a change in a value of the HFN.

In some examples, the one or more conditions includes reception of a control message indicative of a change in structure of the message from a first structure to a second structure. In some examples, the second structure supports an indication of the count value.

In some examples, the configuration component 945 is capable of, configured to, or operable to support a means for receiving configuration information indicative of the one or more conditions.

In some examples, either the report or a control message transmitted by the UE is indicative of one or more PDUs, including at least the PDU, missed by the UE based on the HFN desynchronization, and the PDU component 935 is capable of, configured to, or operable to support a means for receiving, after reception of the message indicative of the HFN, the one or more PDUs missed by the UE, where the PDU is a first received PDU of the one or more PDUs based on the message being indicative of the HFN associated with the PDU.

In some examples, the HFN desynchronization is associated with a first radio link control entity of one or more radio link control entities associated with the network entity, and the link management component 940 is capable of, configured to, or operable to support a means for releasing a communication link associated with the first radio link control entity based on transmission of the report. In some examples, the HFN desynchronization is associated with a first radio link control entity of one or more radio link control entities associated with the network entity, and the link management component 940 is capable of, configured to, or operable to support a means for re-establishing the communication link associated with the first radio link control entity, where transmission of the message indicative of the HFN is based on re-establishment of the communication link.

In some examples, each PDU of the one or more PDUs is associated with a respective count values. In some examples, the one or more PDUs are received in ascending order of the respective count values.

In some examples, the network entity is associated with a first radio link control entity and a second radio link control entity. In some examples, the UE supports a first communication link associated with the first radio link control entity and a second communication link associated with the second radio link control entity in accordance with a dual connectivity configuration. In some examples, the report indicates that the HFN desynchronization is associated with the first radio link control entity and reception of the message is via the first communication link based on the HFN desynchronization being associated with the first radio link control entity.

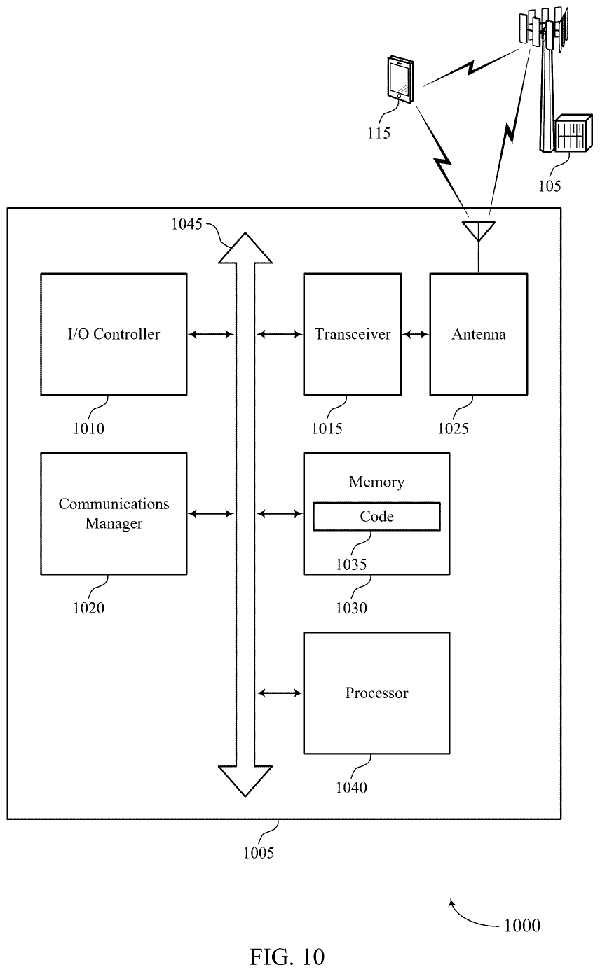

FIG. 10 shows a diagram of a system 1000 including a device 1005 that supports techniques for HFN resynchronization in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for HFN resynchronization). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting a report indicative of HFN desynchronization between the UE and a network entity. The communications manager 1020 is capable of, configured to, or operable to support a means for receiving a message indicative of a HFN associated with a PDU based on transmission of the report, where the UE deciphers the PDU based on the HFN.

By including or configuring the communications manager 1020 in accordance with examples as described herein, the device 1005 may support techniques for HFN resynchronization, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for HFN resynchronization as described herein, or the at least one processor 1040 and the at least one memory 1030 may be otherwise configured to, individually or collectively, perform or support such operations.

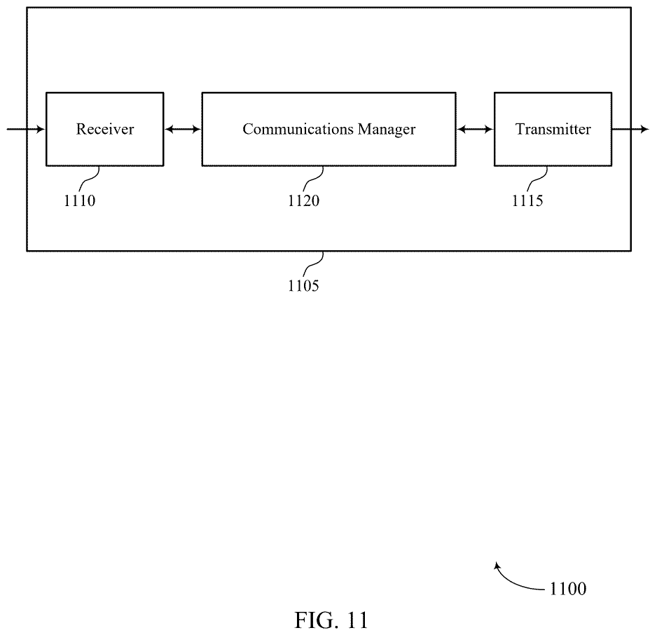

FIG. 11 shows a block diagram 1100 of a device 1105 that supports techniques for HFN resynchronization in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for HFN resynchronization as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for obtaining a report indicative of HFN desynchronization between a UE and the network entity. The communications manager 1120 is capable of, configured to, or operable to support a means for outputting a message indicative of a HFN associated with a PDU in response to obtaining the report, where the network entity ciphers the PDU based on the HFN.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for HFN resynchronization, which may result in reduced processing, reduced power consumption, and more efficient utilization of communication resources, among other advantages.

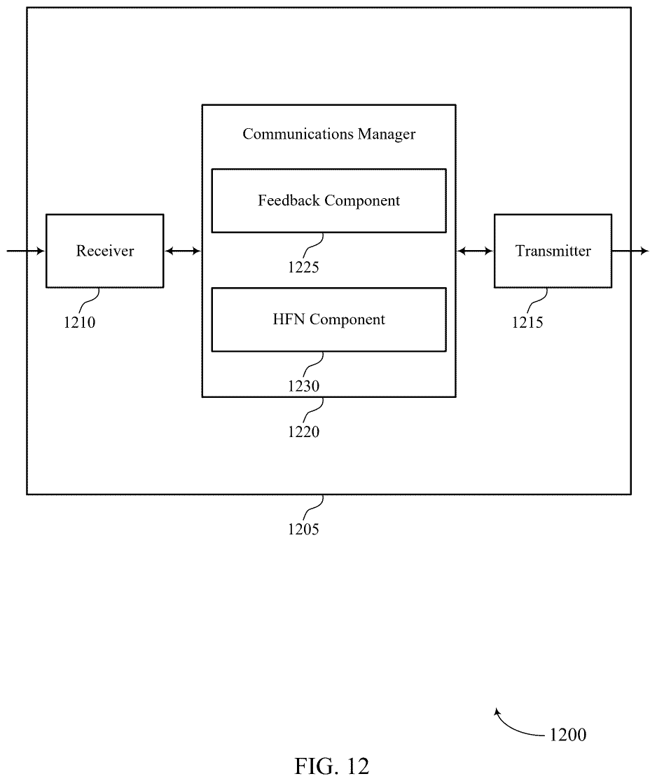

FIG. 12 shows a block diagram 1200 of a device 1205 that supports techniques for HFN resynchronization in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for HFN resynchronization as described herein. For example, the communications manager 1220 may include a feedback component 1225 an HFN component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The feedback component 1225 is capable of, configured to, or operable to support a means for obtaining a report indicative of HFN desynchronization between a UE and the network entity. The HFN component 1230 is capable of, configured to, or operable to support a means for outputting a message indicative of a HFN associated with a PDU in response to obtaining the report, where the network entity ciphers the PDU based on the HFN.

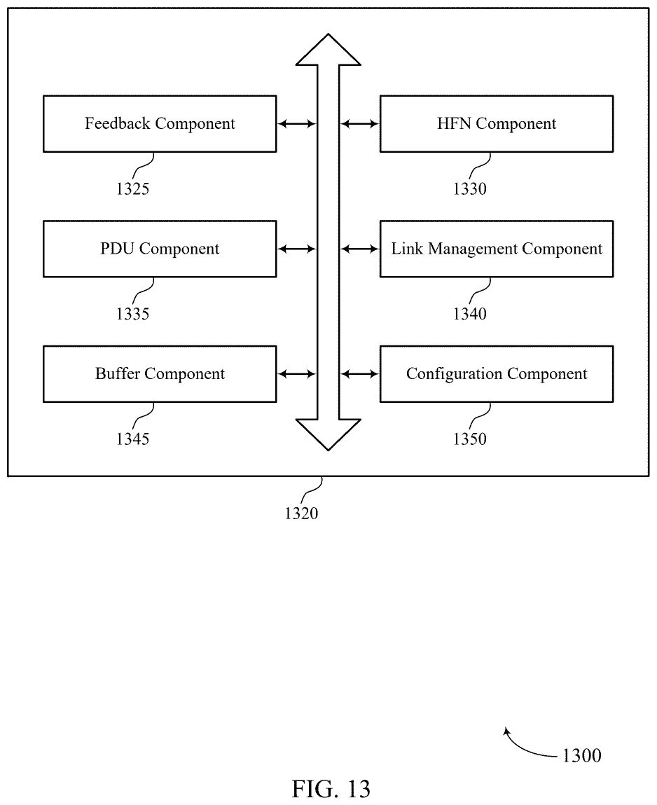

FIG. 13 shows a block diagram 1300 of a communications manager 1320 that supports techniques for HFN resynchronization in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for HFN resynchronization as described herein. For example, the communications manager 1320 may include a feedback component 1325, an HFN component 1330, a PDU component 1335, a link management component 1340, a buffer component 1345, a configuration component 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The feedback component 1325 is capable of, configured to, or operable to support a means for obtaining a report indicative of HFN desynchronization between a UE and the network entity. The HFN component 1330 is capable of, configured to, or operable to support a means for outputting a message indicative of a HFN associated with a PDU in response to obtaining the report, where the network entity ciphers the PDU based on the HFN.

In some examples, the message includes a control message, and the PDU component 1335 is capable of, configured to, or operable to support a means for transmitting, after the control message, the PDU.

In some examples, the control message includes a first field that indicates that a second field in the control message is indicative of the HFNH.

In some examples, the control message indicates a value of the HFN via a quantity of bits in the second field.

In some examples, the message is indicative of a count value, and the message being indicative of the HFN is based on the count value being based on the HFN and an SN associated with the PDU.

In some examples, the message includes an indication that the message is indicative of the count value.

In some examples, the message indicative of the count value is received based on satisfaction of one or more conditions.

In some examples, the one or more conditions includes a change in a value of the HFN.

In some examples, the one or more conditions includes transmission of a control message indicative of a change in structure of the message from a first structure to a second structure. In some examples, the second structure supports an indication of the count value.

In some examples, the configuration component 1350 is capable of, configured to, or operable to support a means for transmitting configuration information indicative of the one or more conditions.

In some examples, either the report or a control message received from the UE is indicative of one or more PDUs, including at least the PDU, missed by the UE based on the HFN desynchronization, and the PDU component 1335 is capable of, configured to, or operable to support a means for transmitting, after transmission of the message indicative of the HFN, the one or more PDUs missed by the UE, where the PDU is a first received PDU of the one or more PDUs based on the message being indicative of the HFN associated with the PDU.

In some examples, the HFN desynchronization is associated with a first radio link control entity of one or more radio link control entities associated with the network entity, and the link management component 1340 is capable of, configured to, or operable to support a means for releasing a communication link associated with the first radio link control entity based on transmission of the report. In some examples, the HFN desynchronization is associated with a first radio link control entity of one or more radio link control entities associated with the network entity, and the link management component 1340 is capable of, configured to, or operable to support a means for re-establishing the communication link associated with the first radio link control entity, where transmission of the message indicative of the HFN is based on re-establishment of the communication link.

In some examples, each PDU of the one or more PDUs is associated with a respective value of a counter. In some examples, the one or more PDUs are received in ascending order of the respective count values.

In some examples, the HFN desynchronization is associated with a first radio link control entity of one or more radio link control entities associated with the network entity, and the buffer component 1345 is capable of, configured to, or operable to support a means for transmitting, from the central unit to the distributed unit, an indication for the distributed unit to clear a buffer associated with the first radio link control entity, where transmission of the one or more PDUs is based on the buffer being cleared.

In some examples, the network entity is associated with a first radio link control entity and a second radio link control entity. In some examples, the first radio link control entity is associated with a first communication link. In some examples, the second radio link control entity is associated with a second communication link. In some examples, the report indicates that the HFN desynchronization is assocaited with the first radio link control entity and transmission of the message is via the first communication link based the HFN desynchronization being associated with the first radio link control entity.

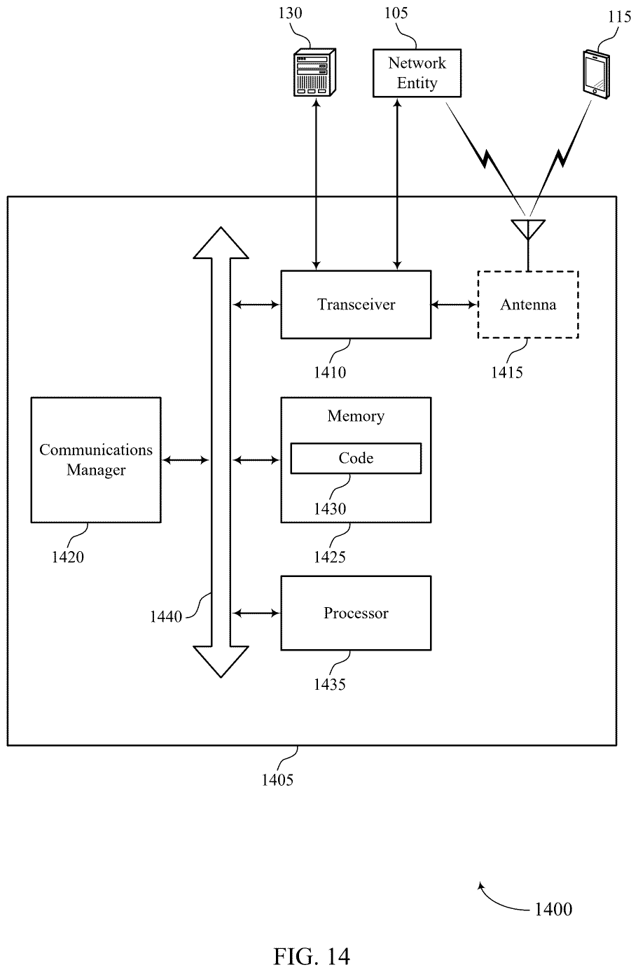

FIG. 14 shows a diagram of a system 1400 including a device 1405 that supports techniques for HFN resynchronization in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for HFN resynchronization). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for obtaining a report indicative of HFN desynchronization between a UE and the network entity. The communications manager 1420 is capable of, configured to, or operable to support a means for outputting a message indicative of a HFN associated with a PDU in response to obtaining the report, where the network entity ciphers the PDU based on the HFN.

By including or configuring the communications manager 1420 in accordance with examples as described herein, the device 1405 may support techniques for HFN resynchronization, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for HFN resynchronization as described herein, or the at least one processor 1435 and the at least one memory 1425 may be otherwise configured to, individually or collectively, perform or support such operations.

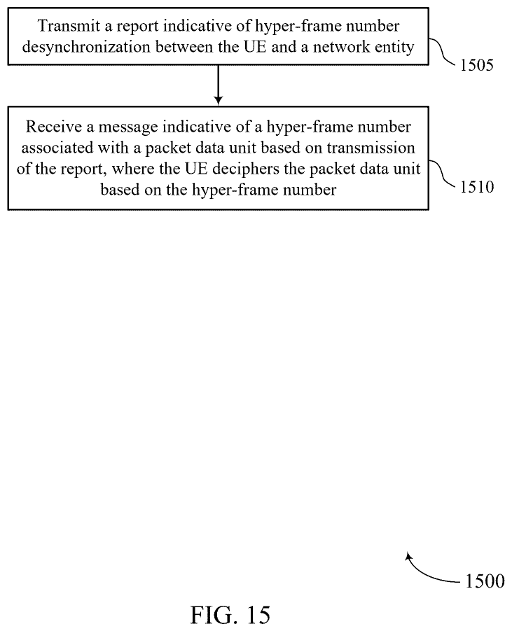

FIG. 15 shows a flowchart illustrating a method 1500 that supports techniques for HFN resynchronization in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting a report indicative of HFN desynchronization between the UE and a network entity. The operations of 1505 may be performed in accordance with examples as disclosed herein. In some examples, aspects of the operations of 1505 may be performed by a reporting component 925 as described with reference to FIG. 9.

At 1510, the method may include receiving a message indicative of a HFN associated with a PDU based on transmission of the report, where the UE deciphers the PDU based on the HFN. The operations of 1510 may be performed in accordance with examples as disclosed herein. In some examples, aspects of the operations of 1510 may be performed by a synchronization component 930 as described with reference to FIG. 9.

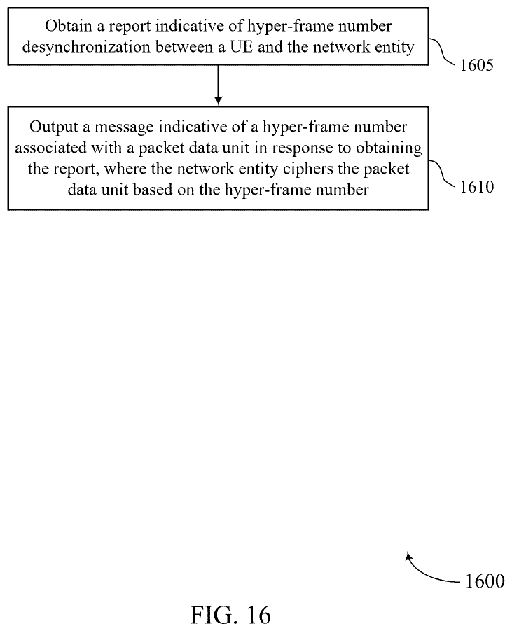

FIG. 16 shows a flowchart illustrating a method 1600 that supports techniques for HFN resynchronization in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a report indicative of HFN desynchronization between a UE and the network entity. The operations of 1605 may be performed in accordance with examples as disclosed herein. In some examples, aspects of the operations of 1605 may be performed by a feedback component 1325 as described with reference to FIG. 13.

At 1610, the method may include outputting a message indicative of a HFN associated with a PDU in response to obtaining the report, where the network entity ciphers the PDU based on the HFN. The operations of 1610 may be performed in accordance with examples as disclosed herein. In some examples, aspects of the operations of 1610 may be performed by an HFN component 1330 as described with reference to FIG. 13.

The following provides an overview of aspects of the present disclosure:
Aspect 1: A method for wireless communications at a UE, comprising: transmitting a report indicative of hyper-frame number (HFN) desynchronization between the UE and a network entity; and receiving a message indicative of a HFN associated with a packet data unit (PDU) based at least in part on transmission of the report, wherein the UE deciphers the PDU based at least in part on the HFN.
Aspect 2: The method of aspect 1, wherein the message comprises a control message, and wherein the method further comprises: receiving, after the control message, the PDU.
Aspect 3: The method of aspect 2, wherein the control message comprises a first field that indicates that a second field in the control message is indicative of the HFN.
Aspect 4: The method of any of aspects 2 through 3, wherein the control message indicates a value of the HFN via a quantity of bits in the second field.
Aspect 5: The method of any of aspects 1 through 4, wherein the message is indicative of a count value, and wherein the message being indicative of the HFN is based at least in part on the count value being based at least in part on the HFN and an SN associated with the PDU.
Aspect 6: The method of aspect 5, wherein the message comprises an indication that the message is indicative of the count value.
Aspect 7: The method of any of aspects 5 through 6, wherein the message indicative of the count value is received based at least in part on satisfaction of one or more conditions.
Aspect 8: The method of aspect 7, wherein the one or more conditions comprises a change in a value of the HFN.
Aspect 9: The method of any of aspects 7 through 8, wherein the one or more conditions comprises reception of a control message indicative of a change in structure of the message from a first structure to a second structure, and the second structure supports an indication of the count value.
Aspect 10: The method of any of aspects 7 through 9, further comprising: receiving configuration information indicative of the one or more conditions.
Aspect 11: The method of any of aspects 1 through 10, wherein either the report or a control message transmitted by the UE is indicative of one or more PDUs, including at least the PDU, missed by the UE based at least in part on the HFN desynchronization, and wherein the method further comprises: receiving, after reception of the message indicative of the HFN, the one or more PDUs missed by the UE, wherein the PDU is a first received PDU of the one or more PDUs based at least in part on the message being indicative of the HFN associated with the PDU.
Aspect 12: The method of aspect 11, wherein the HFN desynchronization is associated with a first radio link control (RLC) entity of one or more RLC entities associated with the network entity, the method further comprising: releasing a communication link associated with the first RLC entity based at least in part on transmission of the report; and re-establishing the communication link associated with the first RLC entity, wherein transmission of the message indicative of the HFN is based at least in part on re-establishment of the communication link.
Aspect 13: The method of any of aspects 11 through 12, wherein each PDU of the one or more PDUs is associated with a respective value of a counter, and the one or more PDUs are received in ascending order of the respective count values.
Aspect 14: The method of any of aspects 1 through 13, wherein the network entity is associated with a first RLC entity and a second RLC entity, the UE supports a first communication link associated with the first RLC entity and a second communication link associated with the second RLC entity in accordance with a dual connectivity configuration, wherein the report indicates that the HFN desynchronization is associated with the first RLC entity, and wherein reception of the message is via the first communication link based at least in part on the HFN desynchronization being associated with the first RLC entity.
Aspect 15: A method for wireless communications at a network entity, comprising: obtaining a report indicative of HFN desynchronization between a UE and the network entity; and outputting a message indicative of a HFN associated with a PDU in response to obtaining the report, wherein the network entity ciphers the PDU based at least in part on the HFN.
Aspect 16: The method of aspect 15, wherein the message comprises a control message, and wherein the method further comprises: transmitting, after the control message, the PDU.
Aspect 17: The method of aspect 16, wherein the control message comprises a first field that indicates that a second field in the control message is indicative of the HFN.
Aspect 18: The method of any of aspects 16 through 17, wherein the control message indicates a value of the HFN via a quantity of bits in the second field.
Aspect 19: The method of any of aspects 15 through 18, wherein the message is indicative of a count value, and wherein the message being indicative of the HFN is based at least in part on the count value being based at least in part on the HFN and an SN associated with the PDU.
Aspect 20: The method of aspect 19, wherein the message comprises an indication that the message is indicative of the value of the counter.
Aspect 21: The method of any of aspects 19 through 20, wherein the message indicative of the count value is received based at least in part on satisfaction of one or more conditions.
Aspect 22: The method of aspect 21, wherein the one or more conditions comprises a change in a value of the HFN.
Aspect 23: The method of any of aspects 21 through 22, wherein the one or more conditions comprises transmission of a control message indicative of a change in structure of the message from a first structure to a second structure, and the second structure supports an indication of the count value.
Aspect 24: The method of any of aspects 21 through 23, further comprising: transmitting configuration information indicative of the one or more conditions.
Aspect 25: The method of any of aspects 15 through 24, wherein either the report or a control message received from the UE is indicative of one or more PDUs, including at least the PDU, missed by the UE based at least in part on the HFN desynchronization, and wherein the method further comprises: transmitting, after transmission of the message indicative of the HFN, the one or more PDUs missed by the UE, wherein the PDU is a first received PDU of the one or more PDUs.
Aspect 26: The method of aspect 25, wherein the HFN desynchronization is associated with a first RLC entity of one or more RLC entities associated with the network entity, the method further comprising releasing a communication link associated with the first RLC entity based at least in part on transmission of the report; and re-establishing the communication link associated with the first RLC entity, wherein transmission of the message indicative of the HFN is based at least in part on re-establishment of the communication link.
Aspect 27: The method of any of aspects 25 through 26, wherein each PDU of the one or more PDUs is associated with a respective count value, and the one or more PDUs are transmitted in ascending order of the respective count values.
Aspect 28: The method of any of aspects 25 through 27, wherein the HFN desynchronization is associated with a first RLC entity of one or more RLC entities associated with the network entity, and wherein the network entity comprises a distributed unit and a central unit, the method further comprising: transmitting, from the central unit to the distributed unit, an indication for the distributed unit to clear a buffer associated with the first RLC entity, wherein transmission of the one or more PDUs is based at least in part on the buffer being cleared.
Aspect 29: The method of any of aspects 15 through 28, wherein the network entity is associated with a first RLC entity and a second RLC entity, the first RLC entity is associated with a first communication link, the second RLC entity is associated with a second communication link, wherein the report indicates that the HFN desynchronization is associated with the first RLC entity, and wherein transmission of the message is via the first communication link based at least in part on the HFN desynchronization being associated with the first RLC entity.
Aspect 30: A UE for wireless communications, comprising one or more memories storing processor-executable code, and one or more processors coupled with the one or more memories and individually or collectively operable to execute the code to cause the UE to perform a method of any of aspects 1 through 14.
Aspect 31: A UE for wireless communications, comprising at least one means for performing a method of any of aspects 1 through 14.
Aspect 32: A non-transitory computer-readable medium storing code for wireless communications, the code comprising instructions executable by one or more processors to perform a method of any of aspects 1 through 14.
Aspect 33: A network entity for wireless communications, comprising one or more memories storing processor-executable code, and one or more processors coupled with the one or more memories and individually or collectively operable to execute the code to cause the network entity to perform a method of any of aspects 15 through 29.
Aspect 34: A network entity for wireless communications, comprising at least one means for performing a method of any of aspects 15 through 29.
Aspect 35: A non-transitory computer-readable medium storing code for wireless communications, the code comprising instructions executable by one or more processors to perform a method of any of aspects 15 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a report indicative of hyper-frame number desynchronization between the UE and a network entity; and
receive a message indicative of a hyper-frame number associated with a packet data unit based at least in part on transmission of the report, wherein the UE deciphers the packet data unit based at least in part on the hyper-frame number.

2. The UE of claim 1, wherein the message comprises a control message, and the one or more processors are individually or collectively further operable to execute the code to cause the UE to:
receive, after the control message, the packet data unit.

3. The UE of claim 2, wherein the control message comprises a first field that indicates that a second field in the control message is indicative of the hyper-frame number. (?)

4. The UE of claim 2, wherein the control message indicates a value of the hyper-frame number via a quantity of bits in the second field.

5. The UE of claim 1, wherein the message is indicative of a count value, and wherein the message being indicative of the hyper-frame number is based at least in part on the count value being based at least in part on the hyper-frame number and a sequence number associated with the packet data unit.

6. The UE of claim 5, wherein the message comprises an indication that the message is indicative of the count value.

7. The UE of claim 5, wherein the message indicative of the count value is received based at least in part on satisfaction of one or more conditions.

8. The UE of claim 7, wherein the one or more conditions comprises a change in a value of the hyper-frame number.

9. The UE of claim 7, wherein the one or more conditions comprises reception of a control message indicative of a change in structure of the message from a first structure to a second structure, and wherein the second structure supports an indication of the count value.

10. The UE of claim 7, wherein the one or more processors are individually or collectively further operable to execute the code to cause the UE to:
receive configuration information indicative of the one or more conditions.

11. The UE of claim 1, wherein either the report or a control message transmitted by the UE is indicative of one or more packet data units, including at least the packet data unit, missed by the UE based at least in part on the hyper-frame number desynchronization, and wherein the one or more processors are individually or collectively further operable to execute the code to cause the UE to:
receive, after reception of the message indicative of the hyper-frame number, the one or more packet data units missed by the UE, wherein the packet data unit is a first received packet data unit of the one or more packet data units based at least in part on the message being indicative of the hyper-frame number associated with the packet data unit.

12. The UE of claim 11, wherein the hyper-frame number desynchronization is associated with a first radio link control entity of one or more radio link control entities associated with the network entity, and the one or more processors are individually or collectively further operable to execute the code to cause the UE to:
release a communication link associated with the first radio link control entity based at least in part on transmission of the report; and
re-establish the communication link associated with the first radio link control entity, wherein reception of the message indicative of the hyper-frame number is based at least in part on re-establishment of the communication link.

13. The UE of claim 11, wherein each packet data unit of the one or more packet data units is associated with a respective value of a counter, and wherein the one or more packet data units are received in ascending order of the respective count values.

14. The UE of claim 1, wherein the network entity is associated with a first radio link control entity and a second radio link control entity, wherein the UE supports a first communication link associated with the first radio link control entity and a second communication link associated with the second radio link control entity in accordance with a dual connectivity configuration, wherein the report indicates that the hyper-frame number desynchronization is associated with the first radio link control entity, and wherein reception of the message is via the first communication link based at least in part on the hyper-frame number desynchronization being associated with the first radio link control entity.

15. A network entity, comprising:
one or more memories storing processor-executable code; and
one or more processors coupled with the one or more memories and individually or collectively operable to execute the code to cause the network entity to:
obtain a report indicative of hyper-frame number desynchronization between a user equipment (UE) and the network entity; and
output a message indicative of a hyper-frame number associated with a packet data unit in response to obtaining the report, wherein the network entity ciphers the packet data unit based at least in part on the hyper-frame number.

16. The network entity of claim 15, wherein the message comprises a control message, and the one or more processors are individually or collectively further operable to execute the code to cause the network entity to:
transmit, after the control message, the packet data unit.

17. The network entity of claim 16, wherein the control message comprises a first field that indicates that a second field in the control message is indicative of the hyper-frame number.

18. The network entity of claim 16, wherein the control message indicates a value of the hyper-frame number via a quantity of bits in the second field.

19. The network entity of claim 15, wherein the message is indicative of a count value, and wherein the message being indicative of the hyper-frame number is based at least in part on the count value being based at least in part on the hyper-frame number and a sequence number associated with the packet data unit.

20. The network entity of claim 19, wherein the message comprises an indication that the message is indicative of the value of the counter.

21. The network entity of claim 19, wherein the message indicative of the count value is received based at least in part on satisfaction of one or more conditions.

22. The network entity of claim 21, wherein the one or more conditions comprises a change in a value of the hyper-frame number.

23. The network entity of claim 21, wherein the one or more conditions comprises transmission of a control message indicative of a change in structure of the message from a first structure to a second structure, and wherein the second structure supports an indication of the count value.

24. The network entity of claim 15, wherein either the report or a control message received from the UE is indicative of one or more packet data units, including at least the packet data unit, missed by the UE based at least in part on the hyper-frame number desynchronization, and wherein the one or more processors are individually or collectively further operable to execute the code to cause the network entity to:
transmit, after transmission of the message indicative of the hyper-frame number, the one or more packet data units missed by the UE, wherein the packet data unit is a first received packet data unit of the one or more packet data units.

25. The network entity of claim 24, wherein the hyper-frame number desynchronization is associated with a first radio link control entity of one or more radio link control entities associated with the network entity, and the one or more processors are individually or collectively further operable to execute the code to cause the network entity to:
release a communication link associated with the first radio link control entity based at least in part on reception of the report; and
re-establish the communication link associated with the first radio link control entity, wherein transmission of the message indicative of the hyper-frame number is based at least in part on re-establishment of the communication link.

26. The network entity of claim 24, wherein each packet data unit of the one or more packet data units is associated with a respective count value, and wherein the one or more packet data units are transmitted in ascending order of the respective count values.

27. The network entity of claim 24, wherein the hyper-frame number desynchronization is associated with a first radio link control entity of one or more radio link control entities associated with the network entity, wherein the network entity comprises a distributed unit and a central unit, and the one or more processors are individually or collectively further operable to execute the code to cause the network entity to:
transmit, from the central unit to the distributed unit, an indication for the distributed unit to clear a buffer associated with the first radio link control entity, wherein transmission of the one or more packet data units is based at least in part on the buffer being cleared.

28. The network entity of claim 15, wherein the network entity is associated with a first radio link control entity and a second radio link control entity, the first radio link control entity is associated with a first communication link, wherein the second radio link control entity is associated with a second communication link, wherein the report indicates that the hyper-frame number desynchronization is associated with the first radio link control entity, and wherein transmission of the message is via the first communication link based at least in part on the hyper-frame number desynchronization being associated with the first radio link control entity.

29. A method for wireless communications at a user equipment (UE), comprising:
transmitting a report indicative of hyper-frame number desynchronization between the UE and a network entity; and
receiving a message indicative of a hyper-frame number associated with a packet data unit based at least in part on transmission of the report, wherein the UE deciphers the packet data unit based at least in part on the hyper-frame number.

30. A method for wireless communications at a network entity, comprising:
obtaining a report indicative of hyper-frame number desynchronization between a user equipment (UE) and the network entity; and
outputting a message indicative of a hyper-frame number associated with a packet data unit in response to obtaining the report, wherein the network entity ciphers the packet data unit based at least in part on the hyper-frame number.
